(19) United States
(12) Patent Application Publication
(10) Pub. No.: US 2013/0031980 A1
(43) Pub. Date: Feb. 7, 2013

(54) Ultrasonic Probe, Production Method Therefor, and Ultrasonic Diagnostic Apparatus

(71) Applicants: Akifumi Sako, Tokyo (JP); Makoto Fukada, Tokyo (JP); Kazunari Ishida, Tokyo (JP)

(72) Inventors: Akifumi Sako, Tokyo (JP); Makoto Fukada, Tokyo (JP); Kazunari Ishida, Tokyo (JP)

(73) Assignee: HITACHI MEDICAL CORPORATION, Tokyo (JP)

(21) Appl. No.: 13/641,695

(22) PCT Filed: Apr. 6, 2011
(86) PCT No.: PCT/JP2011/058687

§ 371 Date: Oct. 16, 2012

(30) Foreign Application Priority Data
Apr. 23, 2010 (JP) 2010-099323

(51) Int. Cl. G01N 29/24; B32B 37/12

(52) U.S. Cl. 73/606; 156/60

(57) ABSTRACT

Disclosed is an ultrasonic probe wherein the warpage of a CMUT due to thermal stress produced at the joint between a backing layer and the CMUT is minimized, thereby improving the durability of the bond between the CMUT and the backing layer. To accomplish this the ultrasonic probe is provided with: a CMUT (20) having vibratory elements that change the electromechanical coupling coefficient or sensitivity according to the bias voltage to be applied; a backing layer (22) adhered to the rear side of the ultrasonic transmission surface of the CMUT (20); and a thermal-stress balancing member (24) to be adhered to the backing layer (22) while being disposed facing the CMUT (20) in such a manner that the backing layer (22) is sandwiched therebetween so as to minimize the warpage of the CMUT (20) due to thermal stress produced between the CMUT (20).

### FIELD OF THE INVENTION

The present invention relates to an ultrasonic probe, a production method therefor and an ultrasonic diagnostic apparatus using a CMUT for transducers.

### DESCRIPTION OF RELATED ART

An ultrasonic diagnostic apparatus transmits ultrasonic waves to an object to be examined via an ultrasonic probe, receives the reflected echo signals from the object by the ultrasonic probe, and executes imaging of a diagnostic image on the basis of the received reflected echo signals. An ultrasonic probe is provided with plural transducers arrayed therein. Ultrasonic transducers have the function to convert the drive signals provided from an ultrasonic-beam forming circuit into ultrasonic waves and transmit the ultrasonic waves to an object, as well as the function to receive the reflected echo signals from the object and convert them into electrical signals.

In recent years, Capacitive Micromachined Ultrasonic Transducers (hereinafter abbreviated as “CMUT”) have been employed for ultrasonic transducers of ultrasonic probes. The CMUT is manufactured by semiconductive microfabrication process, and operated so that electromechanical coupling coefficient changes according to the bias voltage which is applied between the upper electrode and the lower electrode that are formed in such a manner that plural vibratory elements are sandwiched therebetween. The plural vibratory elements convert the drive signals provided from the ultrasonic-beam forming circuit into ultrasonic waves and transmit the ultrasonic waves to an object, as well as receive the reflected echo signals from the object and convert them into electrical signals.

An example of the ultrasonic probe using a CMUT for ultrasonic transducers is disclosed in Patent Document 1. The ultrasonic probe has a configuration in which a backing layer, a thermal-stress suppressing means, a basal plate, a CMUT and an acoustic lens are laminated in that order. The thermal-stress suppressing means suppresses the thermal stress generated by temperature change in the basal plate and the backing layer having different linear expansion coefficients.

### PRIOR ART DOCUMENTS

### Patent Documents

Patent Document 1: W02009/069555

The technique disclosed in Patent Document 1 merely suppresses the thermal stress generated in a basal plate and a backing layer by thermal-stress suppressing means.

However, minimizing the thermal stress generated in the joint between a backing layer and a CMUT is not considered in Patent Document 1.

The objective of the present invention is to provide a ultrasonic diagnostic apparatus, a manufacturing method therefor, and an ultrasonic diagnostic apparatus, capable of improving resistance against thermal stress generated in the joint between a backing layer and a CMUT.

### BRIEF SUMMARY OF THE INVENTION

In order to achieve the above-described objectives, the present invention laminates, viewing from the ultrasonic transmitting surface, a CMUT, a backing layer and a thermal-stress balancing member in that order and adhere them to one another. In other words, the CMUT and the thermal-stress balancing member are disposed facing each other in such a manner that the backing layer is sandwiched therebetween. The CMUT is adhered to the backing layer, and the thermal-stress balancing member is adhered to the backing layer respectively.

Next, the concrete configuration of the present invention will be described.

The ultrasonic probe of the present invention is characterized in comprising:

a CMUT having vibratory elements that change the electromechanical coupling coefficient or sensitivity in accordance with the applied bias voltage;

a backing layer adhered to the back surface of the ultrasonic transmitting surface of the CMUT; and

a thermal-stress balancing member which is placed facing the CMUT in such a manner that the backing layer is sandwiched therebetween and is adhered to the backing layer.

Also, the manufacturing method of the ultrasonic probe related to the present invention is characterized in including:

a first step of adhering the back surface of the ultrasonic transmitting surface of a CMUT to a backing layer; and

a second step of placing the CMUT and a thermal-stress balancing member to face each other in such a manner that the backing layer is sandwiched therebetween, and adhering the thermal-stress balancing member to the backing layer.

Also, the ultrasonic diagnostic apparatus of the present invention comprises:

an ultrasonic probe configured to transmit/receive ultrasonic waves to/from an object to be examined;

a transmission unit configured to activate the ultrasonic probe;

an image generation unit configured to generate an ultrasonic image using the reflected echo signals received by the ultrasonic probe from the object;

a display unit configured to display the ultrasonic image; and

a control unit configured to control the transmission unit, the image generation unit and the display unit,

wherein the ultrasonic probe comprises:

a CMUT provided with vibratory elements that change the electromechanical coupling coefficient or the sensitivity in accordance with the applied bias voltage;

a backing layer to be adhered to the back side of the ultrasonic transmitting surface of the CMUT; and

a thermal-stress balancing member to be placed facing the CMUT in such a manner that the backing layer is sandwiched therebetween, and to be adhered to the backing layer.

In accordance with the present invention, by comprising a thermal-stress balancing member, the thermal stress generated between the thermal-stress balancing member and the backing layer is directed to the direction opposite to the thermal stress generated between the CMUT and the backing layer, which balances each thermal stress.

Therefore, the present invention is capable of minimizing the warpage of a CMUT caused by the thermal stress generated in the joint between a backing layer and the CMUT, whereby improving the durability of adherence in the CMUT and the backing layer.

### EFFECT OF THE INVENTION

In accordance with the present invention, it is possible to provide an ultrasonic probe, the manufacturing method therefor, and an ultrasonic diagnostic apparatus capable of minimizing the warpage of a CMUT caused by the thermal stress generated in the joint between a backing layer and the CMUT, whereby improving the durability of the adherence in the CMUT and the backing unit.

### BRIEF DESCRIPTION OF THE DRAWINGS

FIG. 1 is a block diagram of an ultrasonic diagnostic apparatus 1 in the present invention.

FIG. 2 is a perspective view of an ultrasonic probe 2 of which a part is cut out.

FIG. 3 is a configuration diagram of transducers 21 in FIG. 2.

FIG. 4 is a cross-sectional view of one of vibratory elements 28 in FIG. 3.

FIG. 5 is a view for explaining the principle of setting off the thermal stress using a thermal-stress balancing member 24.

FIG. 6 is a view in a first embodiment showing the result in measurement of the warpage of the ultrasonic probe 2 in the major-axis direction.

FIG. 7 shows finite element models in a second embodiment without a thermal-stress balancing member 24.

FIG. 8 shows finite element models in the second embodiment with a thermal-stress member 24.

FIG. 9 is a view in the second embodiment showing the result in measurement of warpage of the ultrasonic probe 2 in the major-axis direction.

FIG. 10 is a view in a third embodiment showing the result in measurement of warpage of the ultrasonic probe 2 in the major-axis direction.

FIG. 11 is a cross-sectional view in a fourth embodiment of the ultrasonic probe 2 in which thermal-stress balancing members 24-1˜24-5 are disposed.

FIG. 12 is a cross-sectional view in a fifth embodiment of the ultrasonic probe 2 in which thermal-stress balancing members 24a and 24b are disposed.

FIG. 13 is a flowchart showing the process of manufacturing method of an ultrasonic probe in a sixth embodiment.

FIGS. 14 are diagrams showing the manufacturing process indicated in FIG. 13.

### DETAILED DESCRIPTION OF THE INVENTION

The preferable embodiments of the ultrasonic probe and the ultrasonic diagnostic apparatus using the same related to the present invention will be described in detail referring to the attached diagrams.

In the following description and the attached diagrams, the same function parts are represented by the same reference numerals, and the duplicative description thereof is omitted.

(Configuration of Ultrasonic Diagnostic Apparatus 1)

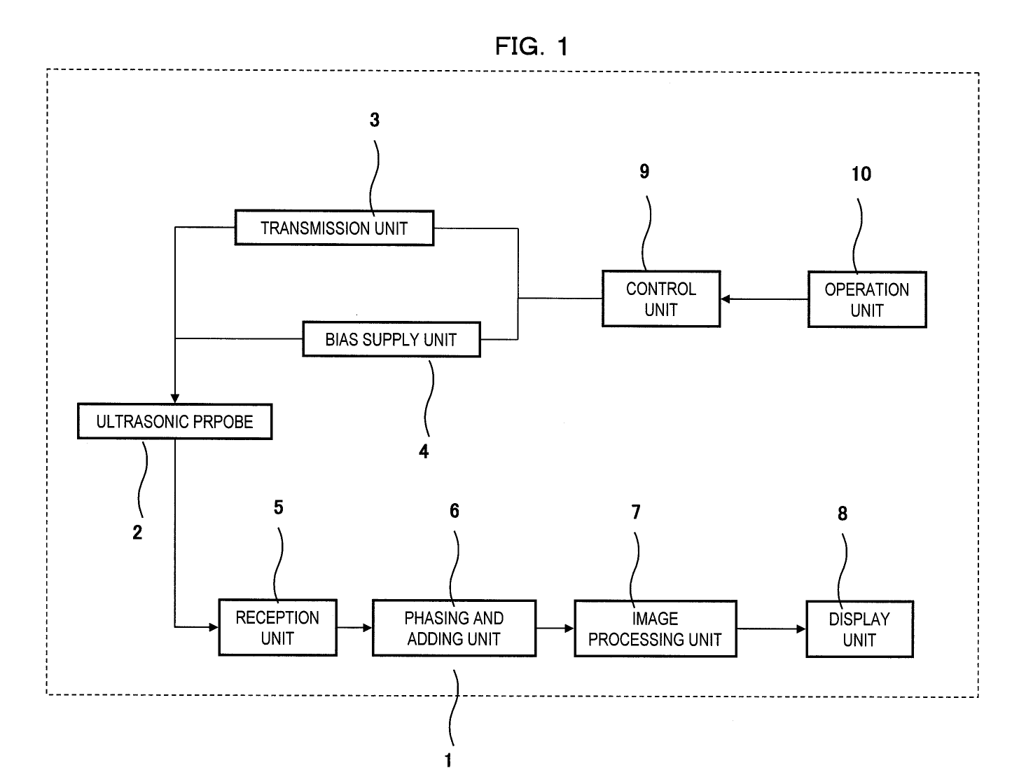

First, the configuration of the ultrasonic diagnostic apparatus 1 will be described referring to FIG. 1.

The ultrasonic diagnostic apparatus 1 related to the present invention is provided with the ultrasonic probe 2, a transmission unit 3, a bias supply unit 4, a reception unit 5, a phasing and adding unit 6, an image processing unit 7, a display unit 8, a control unit 9 and an operation unit 10.

The ultrasonic probe 2 transmits/receives ultrasonic waves to/from an object on which the probe is applied. The ultrasonic waves are transmitted from the ultrasonic probe 2 to the object. The reflected echo signals from the object are received by the ultrasonic probe 2. The transmission unit 3 applies the drive signals for transmitting ultrasonic waves to the ultrasonic probe 2.

The bias supply unit 4 overlaps and applies the bias voltage and the drive signals to the electrode opposite the vibratory elements in the ultrasonic probe 2.

The reception unit 5 also executes the signal processing such as analogue-digital conversion with respect to the reflected signals received by the ultrasonic probe from the object.

The phasing and adding unit 6 executes phasing and adding of the received reflected echo signals.

The image processing unit 7 generates a diagnostic image (for example, a tomographic image or a blood-flow image) on the basis of the phased and added reflected echo signals.

The display unit 8 displays the diagnostic image generated in the image processing unit 7.

The control unit 9 controls the above-described respective components.

The operation unit 10 is an input device such as a trackball, a keyboard or a mouse that gives commands, for example to start diagnosis to the control unit 9.

(Configuration of Ultrasonic Probe 2)

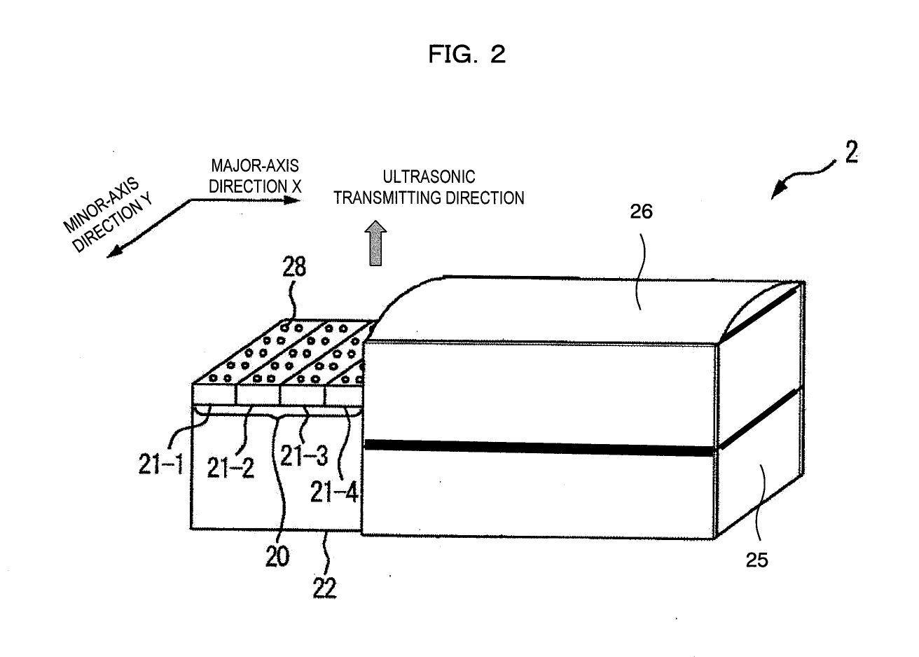

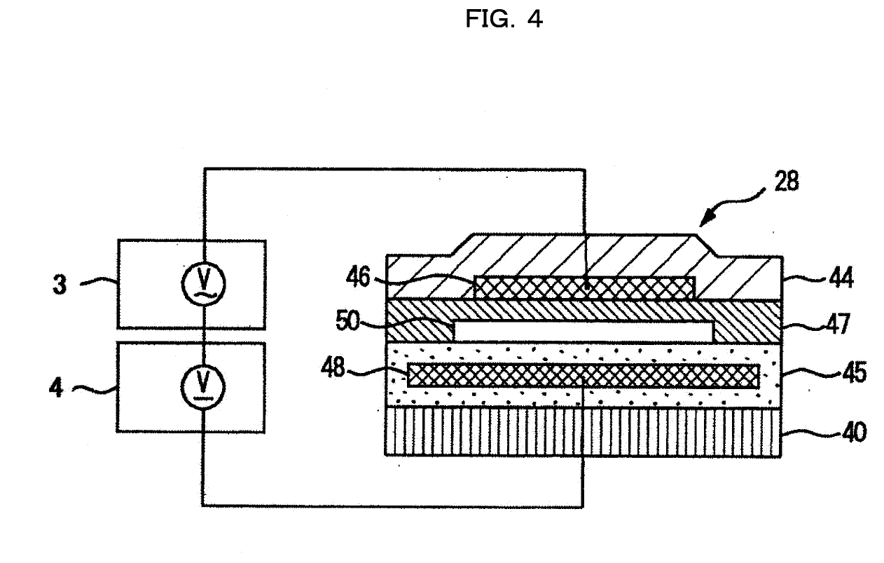

Next, the configuration of the ultrasonic probe 2 will be described referring to FIG. 2˜FIG. 4. FIG. 2 is a perspective view of the ultrasonic probe 2 of which a part is cut out. The ultrasonic probe 2 comprises a CMUT 20. The CMUT 20 is a group of one-dimensionally arrayed transducers in which plural strip-shaped transducers 21-1, 21-2, . . . are arrayed. In each of transducer 21-1, transducer 21-2, . . . , plural vibratory elements are disposed. While a linear-type probe is exemplified in FIG. 2, other types of transducer group may instead be used such as 2-dimensionally-arrayed type or convex-type. Also, 2-dimensional matrix type may be used instead of one-dimensionally arrayed type transducers.

The backing layer 22 is provided on the back-surface side (the opposite side of the ultrasonic transmitting direction) of the CMUT 20. An acoustic lens 26 is provided in the ultrasonic transmitting direction of the CMUT 20. The CMUT 20 and the backing layer 22 are stored in an ultrasonic probe cover 25.

The backing layer 22 absorbs the ultrasonic waves propagated from the CMUT 20 to the back-surface side thereof. The acoustic lens 26 converges the ultrasonic beams transmitted from the back surface side of the CMUT 20.

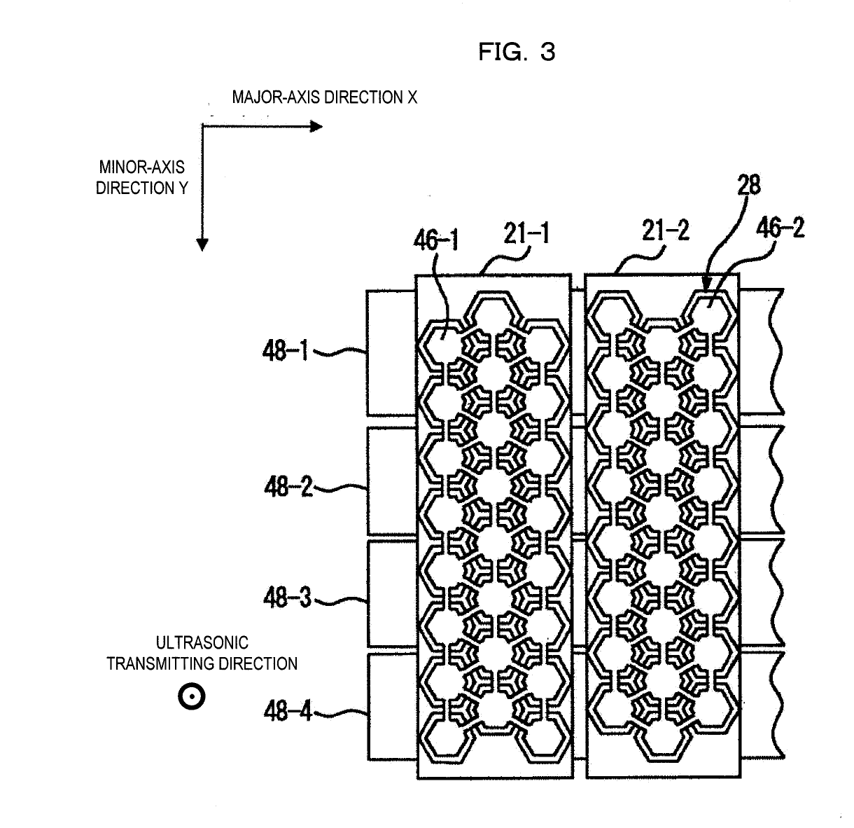

FIG. 3 is a configuration diagram of the transducers 21. FIG. 3 is a planar view of a cutout section of FIG. 2, and the positional relationship between FIG. 2 and FIG. 3 is indicated using the ultrasonic transmitting direction, the major-axis direction X and the minor-axis direction Y. In the ultrasonic transmitting direction of plural vibratory elements 28, upper electrodes 46-1, 46-2, . . . and lower-electrodes 48-1, 48-2, 48-3, 48-4, . . . are disposed so as to coincide with the transducers 21-1, 21-2, . . . .

FIG. 4 is a cross-sectional view of one vibratory element 28 in FIG. 3. The vibratory element 28 is configured by a basal plate 40, a membrane body 44, a membrane body 45 and frame body 47. The vibratory element 28 is formed by microfabrication in semiconductor processing. A vibratory element 28 is equivalent to one element of CMUT. The basal plate 40 is a semiconductor substrate such as silicon wafer, and is disposed on the lower-electrode 48 side. The membrane body 44 and the frame body 47 are formed by semiconducting compound such as silicon compound. The membrane body 44 is provided on the side of the vibratory element which is the nearest to the object (the ultrasonic-wave ejecting side), and the frame body 47 is disposed on the back side of the membrane body 44 (the opposite side of the ultrasonic-wave transmitting side). The upper electrode 46 is provided between the membrane body 44 and the frame body 47. The membrane body 45 is disposed between the frame body 47 and the basal plate 40, and the lower electrode 48 is disposed inside thereof. An internal space 50 which is enclosed by the frame body 47 and the membrane body 45 is to be made as vacuum state or filled with predetermined gas.

The upper electrode 46 and the lower electrode 48 are connected to the bias supply unit 4 which is shown in FIG. 1 configured to apply the direct-current voltage as bias voltage, and also connected to the transmission unit 3 configured to provide the alternating high-frequency voltage as a drive signal for transmitting ultrasonic waves.

When ultrasonic waves are transmitted, a direct-current bias voltage (Va) is applied to the upper electrodes 46 and the lower electrodes 48 of the vibratory elements 28, and an electric field is generated by the bias voltage (Va). The electric field causes the membrane body 44 to generate tensile force, and electromechanical coupling coefficient (Sa) of the membrane body 44 reaches a predetermined value. When a drive signal is provided from the transmission unit 3 to the upper electrode 46, a powerful ultrasonic wave based on the electromechanical coupling coefficient (Sa) is transmitted from the membrane body 44.

Also, when another direct-current bias voltage (Vb) is applied to the upper electrode 48 and the lower electrode 46 of the vibratory element 28 by the bias supply unit 4, an electrical field is generated by the bias voltage (Vb). The tensile force is generated in the membrane body 44 by the electrical field, and the electromechanical coupling coefficient (Sb) of the membrane body 44 reaches a predetermined value. When a drive signal is provided from the transmission unit 3 to the upper electrode 46, a powerful ultrasonic wave based on the electromechanical coupling coefficient (Sb) is transmitted from the membrane body 44.

Here, when the bias voltage is “Va<Vb”, the electromechanical coupling coefficient of the membrane body 44 becomes “Sa<Sb”.

On the other hand, in the case of receiving ultrasonic waves, the volume of the internal space 50 varies because the membrane body 44 is excited by the reflected echo signal generated from the object. The volume variation of the internal space 50 is detected as an electrical signal via the upper electrode 46.

The electromechanical coupling coefficient of the vibratory element 28 is determined by the tensile force added to the membrane body 44. Therefore, by controlling the tensile force of the membrane body 44 by varying the amount of the bias voltage to be applied to the vibratory element 28, the intensity (or acoustic pressure, amplitude) of the ultrasonic wave to be transmitted from the vibratory element can be varied, even when the drive signal with the same amplitude is input.

Next, the principle of the “thermal-stress balancing member 24” which is the subject of the present invention will be described.

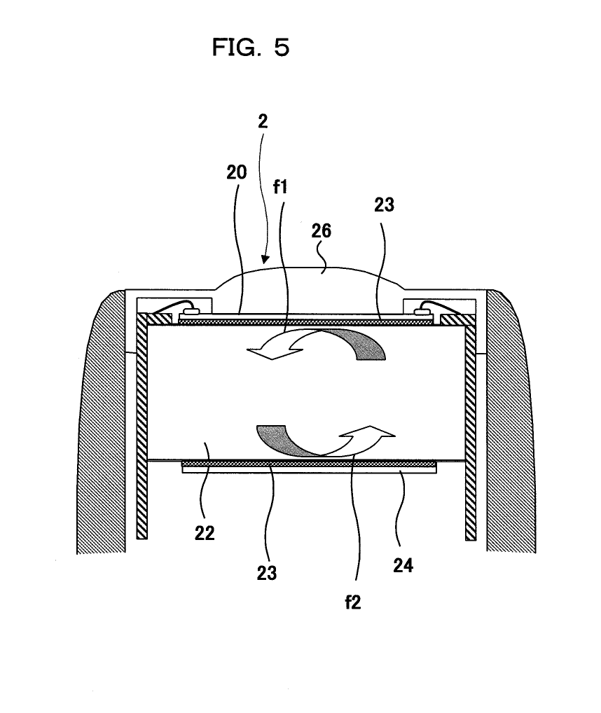

FIG. 5 is a view for explaining the principle of offsetting thermal stress, using the thermal-stress balancing member 24.

In the ultrasonic probe 2, the acoustic lens 26, the CMUT 20, an adhesion layer 23, the backing layer 22, the adhesion layer 23 and the thermal-stress balancing member 24 are disposed in that order, from the upper part to the lower part of the diagram in FIG. 5. The adhesion layer 23 is the layer formed by hardened adhesive agent.

Generally, the CMUT 20 is formed using silicon as a substrate for transducers. The linear expansion coefficient of the CMUT 20 is almost the same as the linear expansion coefficient 3 ppm/°C. of silicon.

The material to be used for the backing layer 22 has the function capable of scattering ultrasonic waves and attenuating sound. The material for the backing layer 22 is generally a complex material formed by fine particles such as tungsten or alumina or resin such as polyvinylchloride plastic, epoxy or polyamide. The linear expansion coefficient of the backing layer 22 is almost the same as the linear expansion coefficient 100 ppm/°C. of the resin to be the base material of the complex material.

Next, the mechanism that generates thermal stress between the CMUT 20 and the backing layer 22 as well as the suppressing method thereof will be described.

Generation of thermal stress between the CMUT 20 and the backing layer 22 is caused by the difference between the respective linear expansion coefficients.

The solution for the above-described cause is to make the linear expansion coefficients of the CMUT 20 and the backing layer 22 the same.

However, the CMUT 20 must be formed by semiconducting material, thus the selection of material for the CMUT 20 side is limited.

Meanwhile, even though the backing layer 22 side has more choices of material, up to about 50 ppm/°C. with optimization of processing is the threshold limit of the linear expansion coefficient. In other words, even if the linear expansion coefficient of the backing layer 22 is made close to that of the CMUT 20 with optimization of processing, a great difference still remains between the CMUT 20 and the backing layer 22, which makes it impossible to avoid generation of a first thermal-stress fl upon integrating both materials by adhesion.

Given this factor, the thermal-stress balancing member 24 is provided in the present invention to minimize the generation of the first thermal-stress f1.

The ultrasonic probe 2 of the present invention comprises the CMUT 20 provided with vibratory elements of which the electromechanical coupling coefficient or sensitivity varies in accordance with the applied bias voltage, the backing layer 22 which is adhered to the back side of the ultrasonic transmitting/receiving surface of the CMUT 20, and the thermal-stress balancing member 24 which is disposed facing the CMUT 20 and minimizes the warpage of the CMUT 20 caused by thermal-stress f1 generated between the backing layer 22 and the CMUT 22 that is adhered to the backing layer 22.

For the thermal-stress balancing member 24, the material approximated to the linear expansion coefficient of the CMUT 20 or the material (linear expansion coefficient is indicated in parentheses) having the smaller linear expansion coefficient than that of the backing layer 22 is selected. The material of thermal-stress balancing member 24 can be selected from among the metals such as aluminum (about 23.6 ppm/°C.), tin (about 20 ppm/°C., iron (about 10 ppm/°C.), gold (about 14.2 ppm/°C.), silver (about 18.9 ppm/°C.), copper (about 16.8 ppm/°C.) and nickel (about 12.8 ppm/°C.), or aluminum base alloy such as stainless steel (about 10.4 ppm/°C.) and duralumin (about 23 ppm/°C.).

Also for suppressing warpage of the CMUT 20, it is appropriate to select the material (linear expansion coefficient is indicated in parentheses) of thermal-stress balancing member 24 from among the nickel base alloys such as silicon (about 3 ppm/°C.) which is the same material for the CMUT 20, alloy 42 (about 5 ppm/°C.), invar (about 1.2 ppm/°C.) and Kovar (about 5 ppm) or inorganic materials such as marble (about 4 ppm), ceramic (about 7 ppm/°C.) and glass (about 9 ppm/°C.), that have linear expansion coefficient of less than 10 ppm which is close to that of silicon.

The thermal-stress balancing member 24 is disposed facing the CMUT 20 in such a manner that the backing layer 22 is sandwiched therebetween. The CMUT 20 and the thermal-stress balancing member 24 are adhered to the backing layer 22 by adhesive agent.

By placing the thermal-stress balancing member 24 on the surface facing the CMUT 20 side of the backing layer 22, the warpage by the first thermal-stress f1 generated between the CMUT 20 and the backing layer 22 and the warpage by a second thermal-stress f2 generated between the thermal-stress balancing member 24 and the backing layer 22 which works in the opposite direction to the first thermal-stress f1 are caused at the same time, so that the second thermal-stress f2 sets off the first thermal-stress f1. As a result, the warpage caused by the first thermal-stress f1 of the CMUT 20 with respect to the backing layer 22 is minimized.

In other words, the thermal-stress balancing member 24 works to minimize the warpage caused by the first thermal-stress f1 generated between the CMUT 20 and the backing layer 22. In this manner, the warpage of the CMUT 20 caused by the thermal stress generated in the joint part of the backing layer 22 and the CMUT 20 can be minimized, whereby improving the durability in adhesion of the CMUT 20 and the backing layer 22.

Also, suppressing warpage of the CMUT 20 means that the positional fluctuation of the vibratory elements in the CMUT 20 caused by the warpage thereof can also be reduced, thus the convergent accuracy of the ultrasonic beams can be improved which leads to the improvement of resolution in the ultrasonic images.

From a standpoint of the method for manufacturing ultrasonic probes, by having the step of adhering the thermal-stress balancing member 24 to the backing layer 22, the warpage between the CMUT 20 and the backing layer 22 caused by the first thermal-stress f1 generated between the CMUT 20 and the backing layer 22 can be minimized, thus the positioning of parts such as mounting of the acoustic lens 26 can be performed easily which improves the assembling performance of the products.

The concrete examples of the above-described principle in the present invention will be described below as embodiments.

### Embodiment 1

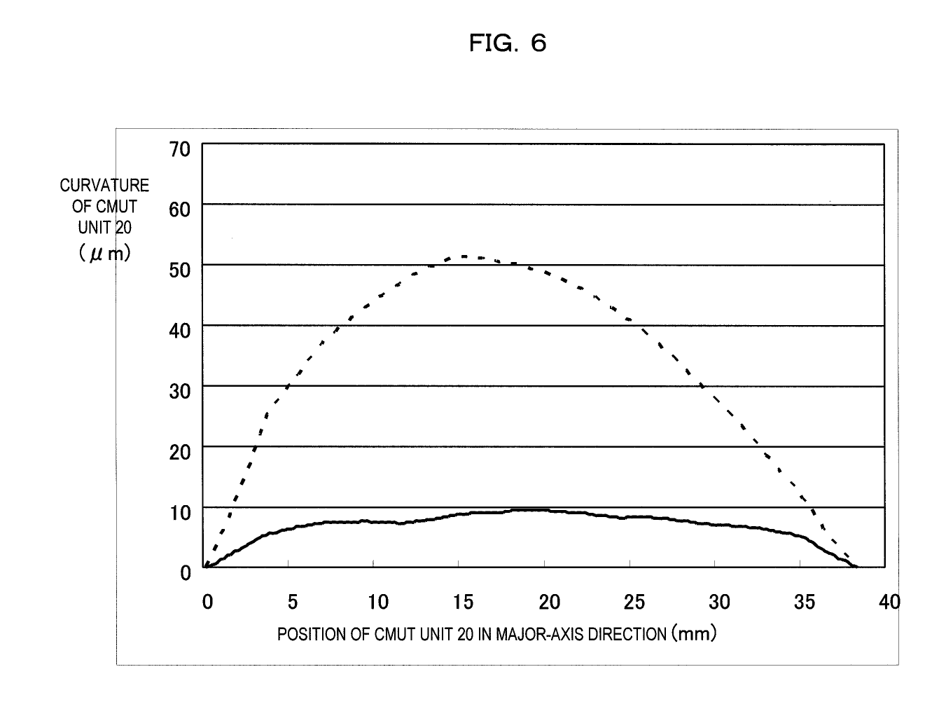

The first embodiment is the case that the thermal-stress balancing member 24 is formed as one structure and the material thereof is silicon, which will be described referring to FIGS. 5 and 6.

FIG. 5 shows the case that the material and the size of the thermal-stress balancing member 24 is the same as the CMUT 20.

First, the first thermal-stress f1 is generated between the CMUT 20 and the backing layer 22, and the second thermal-stress is generated between the thermal-stress balancing member and the backing layer. Since the CMUT 20 and the thermal-stress balancing member 24 are disposed facing each other in such a manner that the baking layer 22 is sandwiched therebetween, the second thermal-stress f2 is generated in the opposite direction to the first thermal-stress f1. This is because the CMUT 20, the backing layer 22 and the thermal-stress balancing member 24 are disposed adjacent to each other, and the temperature condition is practically the same.

In other words, the first thermal-stress f1 and the second thermal-stress f2 have approximately the same values and works respectively in the opposite directions, thus the first thermal-stress f1 is set off by the second thermal-stress f2.

In this manner, the warpage of the CMUT 20 caused by the first thermal-stress f1 generated between the CMUT 20 and the backing layer 22 is avoided, whereby improving the durability regarding the thermal stress generated in the joint between the backing layer 22 and the CMUT 20.

Next, the result of measurement will be described by setting the quality of material and the size of the CMUT 20, the backing layer 22 and the thermal-stress balancing member 24.

The size of the CMUT 20 is set, for example as a cuboid with 50 μm of thickness, 40 mm of major-axis length and 10 mm of minor-axis length. The backing layer 22 is formed by nylon, and adhered to the CMUT 20 with adhesive agent. The adhesive agent is formed by glass or epoxy resin of which the melting point is a temperature of 70° C. Also, the adhesive agent can be any of epoxy adhesive, polyurethane adhesive or silicon adhesive that have low elasticity. The thermal-stress balancing member 24 is adhered to the surface of the backing layer 22 facing the CMUT 20. The thermal-stress balancing member 24 is a silicon substrate with a thickness of 50 μm. The thermal-stress balancing member 24 and the backing layer 22 are adhered using the adhesive agent of the same material as the adhesive agent which is used for adhering the CMUT 20 and the backing layer 22. The respective adhesive agents 23 to be used for adhering the CMUT, the thermal-stress balancing unit 24 and the backing layer 22 are applied with the same thickness and area.

FIG. 6 shows the result of measuring the warpage of the ultrasonic probe 2 in the major-axis direction in the first embodiment.

In FIG. 6, the case without the thermal-stress balancing member 24 is indicated by a dotted line, and the case with the thermal-stress balancing member 24 is indicated by a solid line. In the case without the thermal-stress balancing member 24, the central part of the CMUT 20 is arched by about 50 μm due to the warpage caused by thermal stress. The warpage caused by thermal stress is suppressed to less than 10 μm in the case with the thermal-stress balancing member 24.

Also in the case that the center frequency of the ultrasonic probe 2 is set as 10 MHz, the wavelength 2, of the ultrasonic wave in a human body is about 150 μm. Thus by providing the thermal-stress balancing member 24, the displacement of the phase of about λ/3 can be compensated.

In accordance with the above-described first embodiment, the warpage of the CMUT 20 caused by the thermal stress generated in the joint between the CMUT 20 and the backing layer 22 can be minimized, whereby improving the durability of the adhesion of the CMUT 20 and the backing layer 22.

Also, the first embodiment is created in the condition that the thermal-stress balancing member 24 is made of the same material and the shape as those of the CMUT 20, as well as the adhesive agent used for respectively adhering the CMUT 20, the backing layer 22 and the thermal-stress balancing member 24 is also applied with the same glass or epoxy resin of which the melting point is 70-degrees temperature, in the same thickness and area.

Therefore, the thermal stress of the CMUT 20 and the backing layer 22 can be easily minimized without calculating each of the thermal stress generated respectively between the CMUT 20 and the backing layer 22 or between the thermal-stress balancing member 24 and the backing layer 22.

### Embodiment 2

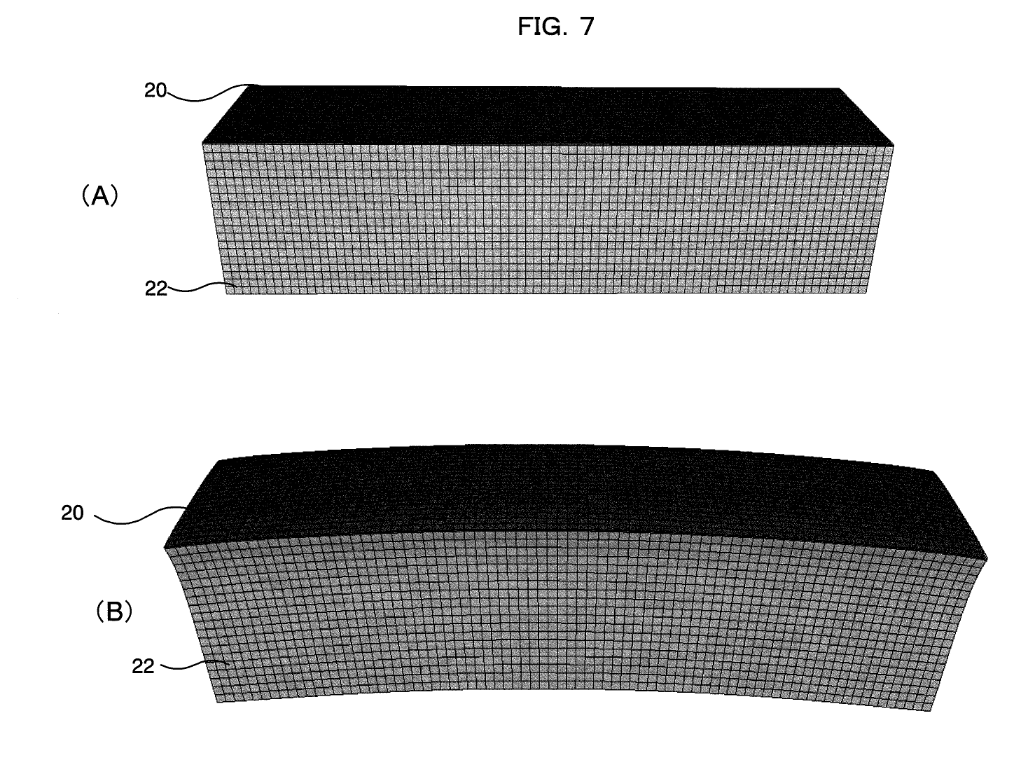

The second embodiment is the case that the thermal-stress balancing member 24 is formed as one structure using silicon as its material, and the size thereof is different from the first embodiment, which will be described referring to FIGS. 7˜9.

First, the material and the size are set for the CMUT 20, the backing layer 22 and the thermal-stress balancing member 24.

The CMUT 20 is set as having the thickness of 100 μm, the major-axis length of 40 mm and the minor-axis length of 10 mm, and is adhered to the backing layer 22. The substrate of the backing layer 22 is epoxy resin. The thermal-stress balancing member 24 is formed by silicon and the thickness thereof is 100 μm. Also, the thermal-stress balancing member 24 is placed at a part to be the surface of the backing layer 22 facing the CMUT 20.

Next, the warpage of the CMUT 20 will be compared between the cases with and without the thermal-stress balancing member 24 in the above-described condition of the set material and size of the CMUT 20, the backing layer 22 and the thermal-stress balancing member 24.

The comparison is analyzed by the thermal-stress deformation analysis using the finite element method. The thermal-stress analysis is performed by verifying the thermal-stress deformation amount in the case that 100° C. is set as the glass-transition temperature in the adhesive portion, i.e. the thermal-stress zero-point upon adhering the CMUT 20 to the backing layer 22, and the temperature is cooled down to 20° C. which is room temperature.

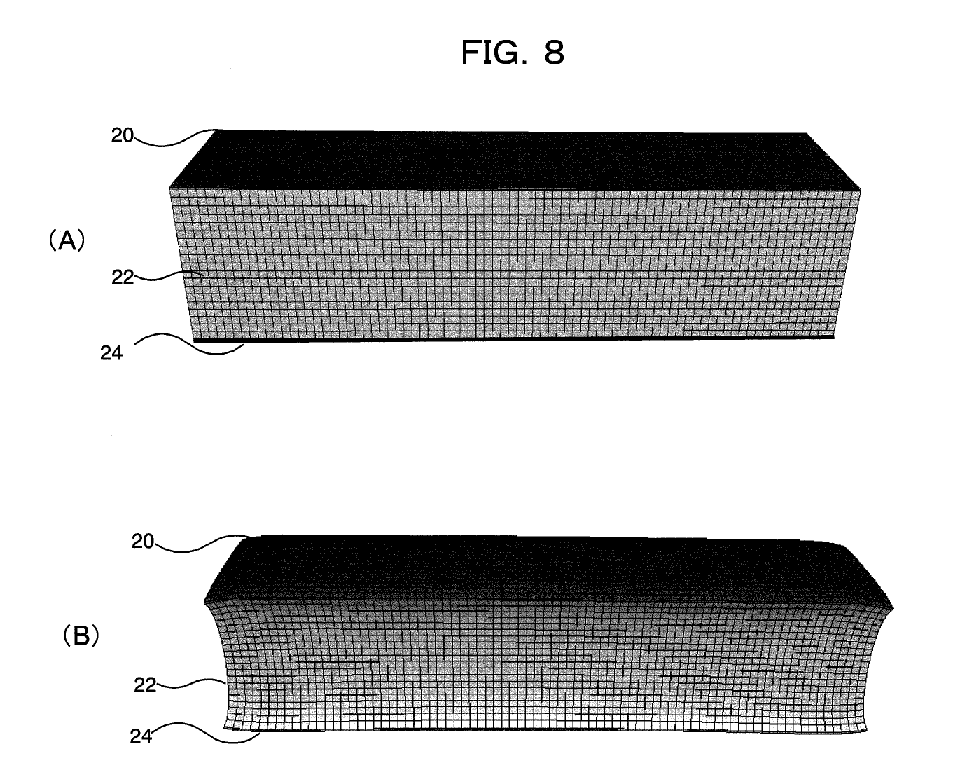

FIG. 7 shows an finite element model of the case in the second embodiment of only the CMUT 20 and the backing layer 22 without the thermal-stress balancing unit 24, and FIG. 8 shows an finite element model of the CMUT 20, the backing layer 22 and the thermal-stress balancing member 24. The condition prior to the temperature change is indicated in (A) of FIGS. 7 and 8, and the condition after the temperature change is indicated in (B) of FIGS. 7 and 8.

In FIG. 7(B), the warpage is generated in the manner that the model is arched in the central part of CMUT 20 due to the difference of the linear expansion coefficients and rigidity compared to FIG. 7(A).

On the other hand, in FIG. 8(B), the arch in the central part of the CMUT 20 is suppressed compared to FIG. 7 (B) by having the thermal-stress balancing member 24.

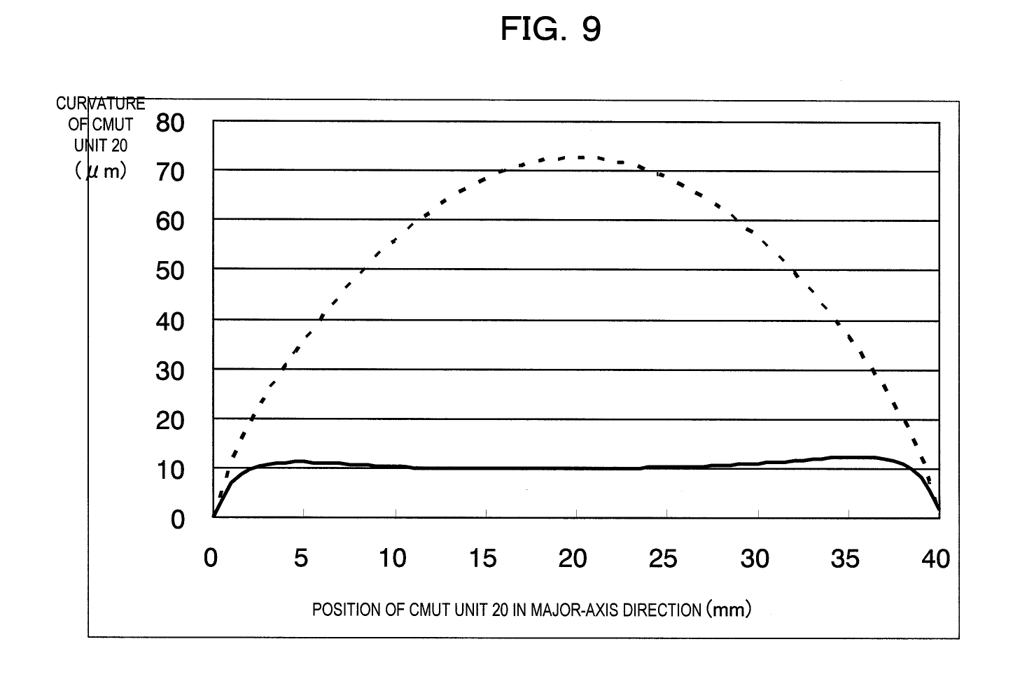

FIG. 9 shows the result of measuring the warpage of the CMUT 20 in the major-axis direction of the ultrasonic probe 2 in the second embodiment.

In the diagram, the dotted line indicates the case without thermal-stress balancing member 24, and the solid line indicates the case with the thermal-stress balancing member 24.

While the warpage is about 70 μm in the case without the thermal-stress balancing member 24, the warpage can be suppressed down to about 10 μm in the case with the thermal-stress balancing member 24.

Particularly, the warpage is less than 3 μm in the central part of the CMUT 20 in the major-axis direction (the part where the position in the major-axis direction of the CMUT 20 is 5˜35 mm) .

While some amount of warpage is generated due to temperature change in the end portions of the major axis of the CMUT 20, it is the part which is generally not in use.

In this manner, the central part of in the major axis of a commonly used CMUT 20 is the part where no or little warpage is generated in actual use, thus the influence of warpage can be minimized by disposing the vibratory elements 28 in the central part in the major axis of the CMUT 20.

In accordance with the above-described second embodiment, the warpage caused by the thermal stress generated in the joint between the backing layer 22 and the CMUT 20 can be minimized, thereby improving the durability of the adhesion of the CMUT 20 and the backing layer 22.

Also, since the second embodiment verified by the finite element method that the warpage is unevenly distributed at the positions in the major-axis direction of the CMUT 20, the influence of warpage can be minimized by disposing the vibratory elements 28 in the portion where little warpage is generated, which makes it possible to obtain highly accurate images.

### Embodiment 3

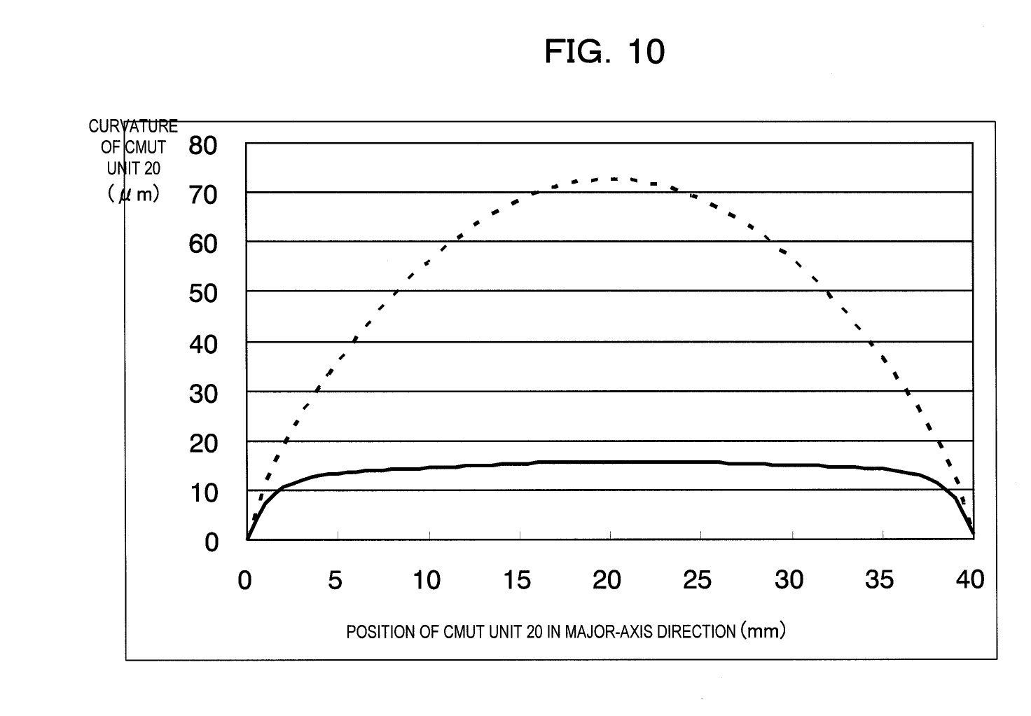

The third embodiment describes the case that the thermal-stress balancing member 24 is formed by one structure and the material of the thermal-stress balancing member 24 is alloy 42, referring to FIGS. 5 and 10.

First, the material and the size are set for the CMUT 20, the backing layer 22 and the thermal-stress balancing member 24. The CMUT 20 is set as having the thickness of 100 μm, the major-axis length of 40 mm and the minor-axis length of 10 mm, and is adhered to the backing layer 22.

The thermal-stress balancing member 24 formed by alloy 42 with a thickness of 100 μm is provided to the backing layer 22.

FIG. 10 shows the result in the third embodiment of measuring the warpage of the ultrasonic probe 2 in the long-axis direction.

In the diagram, the dotted line indicates the case without the thermal-stress balancing member 24, and the solid line indicates the case with the thermal-stress balancing member 24.

The warpage of about 70 μm is indicated in the case without the thermal-stress balancing member 24. On the other hand, the warpage can be suppressed down to about 15 μm in the case with the thermal-stress balancing member 24. Particularly, the warpage is less than 5 μm in the central part (5˜35mm) in the major-axis direction (X) of the CMUT 20 shown in FIG. 2.

In the above-described third embodiment, since the warpage of the CMUT 20 caused by the thermal stress generated in the joint between the backing layer 22 and the CMUT 20 can be minimized, it is possible to improve the durability of adhesion of the CMUT 20 and the backing layer 22.

Also, the above-described improvement of durability in the third embodiment can be verified even the material of the thermal-stress balancing member 24 is different from silicon.

### Embodiment 4

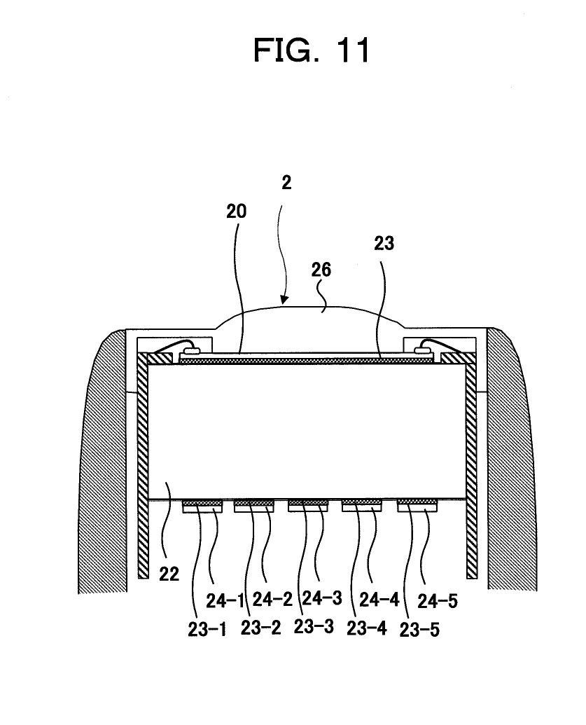

The fourth embodiment describes the case that the thermal-stress balancing member 24 is formed by plural structures and the material thereof is silicon, referring to FIG. 11.

FIG. 11 is a cross-sectional view of the ultrasonic probe 2 in the fourth embodiment.

The CMUT 20 is, for example a cuboid with the thickness of 50 μm, the major-axis length of 40 mm and the minor-axis length of 10 mm. The backing layer is formed by nylon, and the CMUT 20 is adhered thereto by an adhesive agent. The adhesive agent is formed by glass or epoxy resin of which the melting point is 70° C. The thermal-stress balancing member 24 is formed by plural structures 24-1, 24-2, 24-3, 24-4 and 24-5, and are adhered respectively to the surface of the backing layer facing the CMUT 20. The respective thermal-stress balancing members 24-1, 24-2, 24-3, 24-4 and 24-5 are formed by the silicon substrate with a thickness of 50 μm, and are adhered to the surface facing the CMUT 20 using the adhesive agent of the same material as the adhesive agent which is used for adhering the CMUT 20 and the backing layer 22. While the thermal-stress balancing members 24 are formed by being divided into five pieces compared to the one-structured arrangement thereof in the first embodiment, the number of divisions can be any plural number without being limited to five.

With respect to the warpage generated by the thermal stress of the CMUT 20 and the backing layer 22, the rigidity of the thermal-stress balancing members 24-1, 24-2, 24-3, 24-4 and 24-5 works like a splint.

In accordance with the above-described fourth embodiment, the warpage of the CMUT 20 caused by the thermal stress generated in the joint between the CMUT 20 and the backing layer 22 can be minimized, whereby improving the durability of the adhesion of the CMUT 20 and the backing layer 22.

Also, in the fourth embodiment, the weight of the thermal-stress balancing members 24-1˜24-5 is reduced compared to the thermal-stress balancing member 24 in the first embodiment which is formed by one structure, due to the spaces between the adjacent thermal-stress balancing members.

Accordingly, the fourth embodiment can reduce weight of ultrasonic probes compared to the first embodiment.

### Embodiment 5

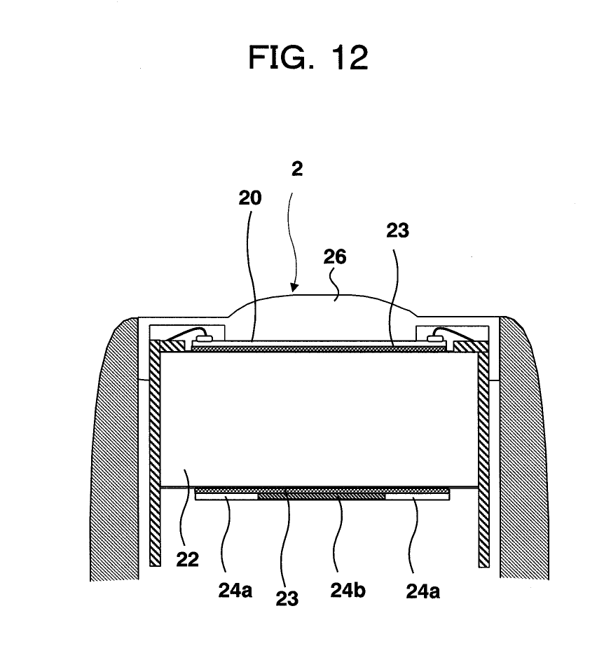

The fifth embodiment describes the case, referring to FIG. 12, that the thermal-stress balancing member is formed by plural kinds of material, for example a central part 24b thereof is formed by silicon and the peripheral part 24a is formed by alloy 42.

FIG. 12 is a cross-sectional view of the ultrasonic probe 2 in the fifth embodiment.

As in the fourth embodiment, the CMUT 20 is set, for example as a cuboid with the thickness of 50 μm, the major-axis length of 40 mm and the minor-axis length of 10 mm. The backing layer 22 is formed by nylon, and the CMUT 20 unit is adhered thereto by adhesive agent. The adhesive agent is formed by glass or epoxy resin of which the melting point is 70° C. In the thermal-stress balancing member, the linear expansion coefficient of the part facing the central part of the CMUT 20 (a group of vibratory elements) in the major-axis direction is made smaller than that of the part facing the peripheral part thereof. In concrete terms, the central part 24b of the thermal-stress balancing member is formed by silicon and a peripheral part 24a is formed by alloy 42. The thermal-stress balancing member is adhered to the surface of the backing layer 22 facing the CMUT 20. The thermal-stress balancing member 24 is silicon substrate with the thickness of 50 μm. The thermal-stress balancing member 24 and the backing layer 22 are adhered to each other using the adhesive agent of the same material which is used for adhering the CMUT 20 and the backing layer 22.

In thermal-stress balancing members, it is significant to effectively minimize the warpage in the major-axis direction of the CMUT 20 where the warpage caused by thermal stress generated in the CMUT 20 and the backing layer 22 is maximized. The position where the warpage is maximized is the vicinity of the central part of the CMUT 20 in the major-axis direction, thus it is appropriate to dispose the material of which the linear expansion coefficient is approximated to that of the CMUT 20 in the central part.

In accordance with the above-described embodiment 5, the warpage caused by the thermal stress generated in the joint between the backing layer 22 and the CMUT 20 can be minimized, whereby improving the durability in adhesion of the CMUT 20 and the backing layer 22.

Also, the fifth embodiment is capable of minimizing the thermal stress in the vicinity of the central part of the CMUT 20 in the major-axis direction, by using silicon (linear expansion coefficient: 3 ppm/°C.) of which the linear expansion coefficient is approximated to 3 ppm/°C. of the CMUT 20 in the central part 24b of the thermal-stress balancing member, and by using alloy 42 (linear expansion coefficient: 5 ppm/°C.) in the periphery part of the thermal-stress balancing member.

### Embodiment 6

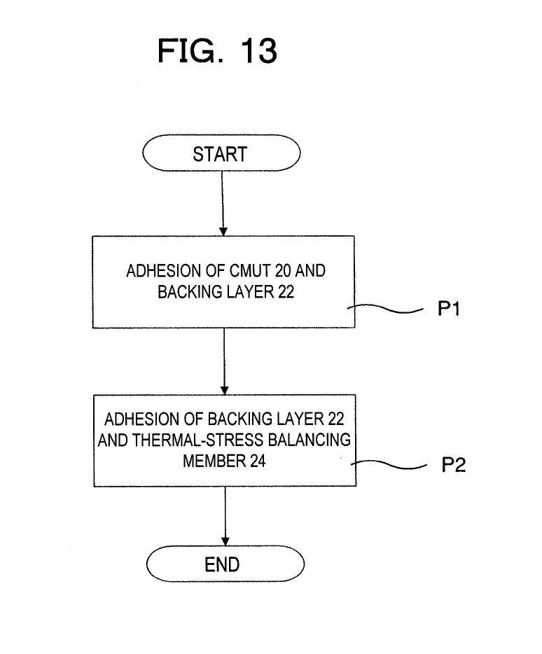

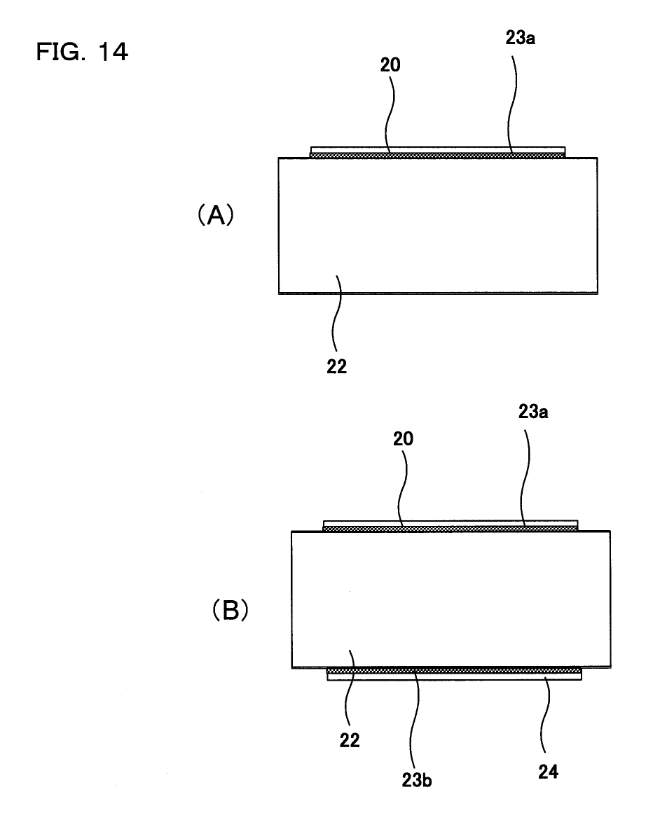

An example of the method for manufacturing an ultrasonic probe related to the present invention will be described referring to FIG. 13 and FIG. 14.

FIG. 13 is a flowchart of the process in the method of manufacturing an ultrasonic probe, and FIG. 14 is a view showing the manufacturing process indicated in FIG. 13. FIG. 14(A) shows the state that a first process (P1) is completed, and FIG. 14(B) shows the state that a second process (P2) is completed.

The method of manufacturing an ultrasonic probe related to the present invention will be described by each following process.

The first process (P1) : As shown in FIG. 14(A), adhesive agent will be applied on the surface in the upper part in the diagram of the backing layer 22. The back side of the ultrasonic-wave transmitting/receiving surface of the CMUT 20 is placed on the part wherein the adhesive agent is applied and pushed down. In this manner, the back side of the ultrasonic-wave transmitting/receiving surface of the CMUT 20 and the backing layer 22 are adhered to each other by the adhesive agent, so as to form an adhesive layer 23a.

The second process (P2): As shown in FIG. 14(B), the to the backing layer 22, so as to form an adhesive layer 23b. The backing layer 22 is placed between the thermal-stress balancing member 24 and the backing layer 22. In other words, thermal-stress balancing member 24 is disposed facing the CMUT 20 in such a manner that the backing layer 22 is sandwiched therebetween.

It is preferable that the adhesive agent and the adhesive agent are of the same material, and are applied with the same thickness and area.

In accordance with the above-described embodiment 6, the warpage of the CMUT 20 caused by the thermal stress generated in the joint between the backing layer 22 and the CMUT 20 can be minimized by the second process (P2), whereby making it possible to provide the method of manufacturing an ultrasonic probe capable of improving the durability of the adhesion between the CMUT 20 and the backing layer 22.

The preferable embodiments of the ultrasonic probe, the manufacturing method therefor and the ultrasonic diagnostic apparatus according to the present invention have been described referring to the attached drawings. However, the present invention is not limited to these embodiments. It is obvious that persons skilled in the art can make various kinds of alterations or modifications within the scope of the technical idea disclosed in this application, and it is present invention is not limited to these embodiments. It is obvious that persons skilled in the art can make various kinds of alterations or modifications within the scope of the technical idea disclosed in this application, and it is understandable that they belong to the technical scope of the present invention.

### Description of Reference Numerals

20: CMUT
22: backing layer
24: thermal-stress balancing member

1. An ultrasonic probe comprising:
a CMUT provided with vibrant elements that change the electromechanical coupling coefficient or sensitivity according to the applied bias voltage;
a backing layer to be adhered to the back side of the ultrasonic transmitting/receiving surface of the CMUT; and
a thermal-stress balancing member to be adhered to the backing layer while being disposed facing the CMUT in such a manner that the backing layer is sandwiched therebetween, configured to suppress the warpage of the CMUT from the backing layer caused by the thermal stress generated between the CMUT and the backing layer.

2. The ultrasonic probe according to claim 1, wherein the thermal-stress balancing member is formed by the material having the linear expansion coefficient smaller than that of the backing layer.

3. The ultrasonic probe according to claim 1, wherein the thermal-stress balancing member is formed by the material of which the linear expansion coefficient is less than 10 ppm/°C.

4. The ultrasonic probe according to claim 3, wherein the thermal-stress balancing member is formed by any material of silicon, alloy 42, ceramic, glass, aluminum, aluminum compound, stainless steel, nickel compound or marble.

5. The ultrasonic probe according to claim 1, wherein the thermal-stress balancing member has the same size as the CMUT.

6. The ultrasonic probe according to claim 1, wherein the adhesive agent to adhere the thermal-stress balancing member and the backing layer is formed by the same material of the adhesive agent to adhere the CMUT and the backing layer.

7. The ultrasonic probe according to claim 1, wherein the thermal-stress balancing member is divided into plural pieces.

8. An ultrasonic probe according to claim 1, wherein the thermal-stress balancing member is configured such that the linear expansion coefficient of the part facing the central portion of the group of vibrant elements in the major-axis direction is smaller than that of the part facing the peripheral portion thereof.

9. A method of manufacturing an ultrasonic probe including:
a first process of adhering the back side of the ultrasonic transmitting/receiving surface of a CMUT and a backing layer; and
a second process of disposing a thermal-stress balancing member facing the CMUT in such a manner that the backing layer is sandwiched therebetween, and adhering the thermal-stress balancing member to the backing layer.

10. An ultrasonic diagnostic apparatus comprising:
an ultrasonic probe configured to transmit/receive ultrasonic waves to an object to be examined;
a transmission unit configured to activate the ultrasonic probe;
an image creation unit configured to create an ultrasonic image using the reflected signals received from the object by the ultrasonic probe;
a display unit configured to display the ultrasonic image, and
a control unit configured to control the transmission unit, the image creation unit and the display unit,
wherein the ultrasonic probe is in accordance with claim 1.
